(19) United States
(12) Patent Application Publication
(10) Pub. No.: US 2022/0005083 A1
(43) Pub. Date: Jan. 6, 2022

(54) Remote Assistance Systems And Methods

(71) Applicant: Home Experience LLC, Chicago, IL (US)

(72) Inventors: Alan Patterson, Cambridge (GB); Darren Garvey, Cambridge (GB); Matthew Mason, Cambridge (GB); Simon Weaver, San Mateo, CA (US); Vincent Payen, Chicago, IL (US); Nicole Hibbard Lyon, San Jose, IL (US)

(21) Appl. No.: 16/920,130

(22) Filed: Jul. 2, 2020

(51) Int. Cl. G06Q 30/02; G06F 16/9032; G06Q 10/00

(52) U.S. Cl. CPC G06Q 30/0281; G06Q 10/20; G06F 16/90332

(57) ABSTRACT

Example remote assistance systems and methods are described. In one implementation, a diagnostics system receives a description of a home-related issue from a user and identifies a user profile associated with the user. The diagnostics system further determines a complexity associated with resolving the issue and determines the user's ability to perform activities to resolve the issue based on the user profile and the complexity associated with resolving the issue. The diagnostics system then determines a level of support based on the user's ability to perform activities to resolve the issue.

### TECHNICAL FIELD

The present disclosure relates to systems and methods that provide remote assistance to homeowners and other users.

### BACKGROUND

Homeowners and other individuals often need assistance with certain problems in their home, office, or other location. For example, a homeowner may need help with a malfunctioning appliance, leaking roof, broken furnace, plumbing problem, and the like. In the case of a severe problem, the homeowner may need immediate help to resolve the problem and mitigate damage to their home. In this type of situation, the homeowner may not be able to wait for a repair technician to visit their home in person. Thus, it is important that the homeowner have fast access to reliable assistance with their problem.

In other situations, the problem may not be an emergency, but the homeowner needs help determining what to do next. For example, the homeowner may not understand if there's a simple fix to the problem or if they need to consult an expert technician. In this situation, the homeowner wants help resolving their problem without wasting money on an unnecessary service call.

Without a source of assistance, homeowners may feel frustrated and worried about potential damage and expenses when faced with a problem in their home.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1 is a block diagram illustrating an environment within which an example embodiment may be implemented.

FIG. 2 is a block diagram illustrating an embodiment of a diagnostic system, which includes a diagnostics engine.

FIG. 3 is a block diagram illustrating an embodiment of a diagnostics engine.

FIG. 4 is a flow diagram illustrating an embodiment of a method for diagnosing a problem.

FIG. 5 is a flow diagram illustrating an embodiment of a method for selecting a tier of service.

FIG. 6 is a flow diagram illustrating an embodiment of a method for interacting with a customer to resolve the customer's issue.

FIG. 7 is a flow diagram illustrating an embodiment of a method for generating questions to ask a customer.

FIG. 8 is a block diagram illustrating an example computing device suitable for implementing the systems and methods described herein.

### DETAILED DESCRIPTION

In the following disclosure, reference is made to the accompanying drawings, which form a part hereof, and in which is shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Implementations of the systems, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter is described in language specific to structural features and/or methodological acts, it is to be understood that the subject matter defined in the appended claims is not necessarily limited to the described features or acts described herein. Rather, the described features and acts are disclosed as example forms of implementing the claims.

Those skilled in the art will appreciate that the disclosure may be practiced in network computing environments with many types of computer system configurations, including, an in-dash vehicle computer, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the description and claims to refer to particular system components. As one skilled in the art will appreciate, components may be referred to by different names. This document does not intend to distinguish between components that differ in name, but not function.

It should be noted that the sensor embodiments discussed herein may comprise computer hardware, software, firmware, or any combination thereof to perform at least a portion of their functions. For example, a sensor may include computer code configured to be executed in one or more processors, and may include hardware logic/electrical circuitry controlled by the computer code. These example devices are provided herein for purposes of illustration, and are not intended to be limiting. Embodiments of the present disclosure may be implemented in further types of devices, as would be known to persons skilled in the relevant art(s).

At least some embodiments of the disclosure are directed to computer program products comprising such logic (e.g., in the form of software) stored on any computer useable medium. Such software, when executed in one or more data processing devices, causes a device to operate as described herein.

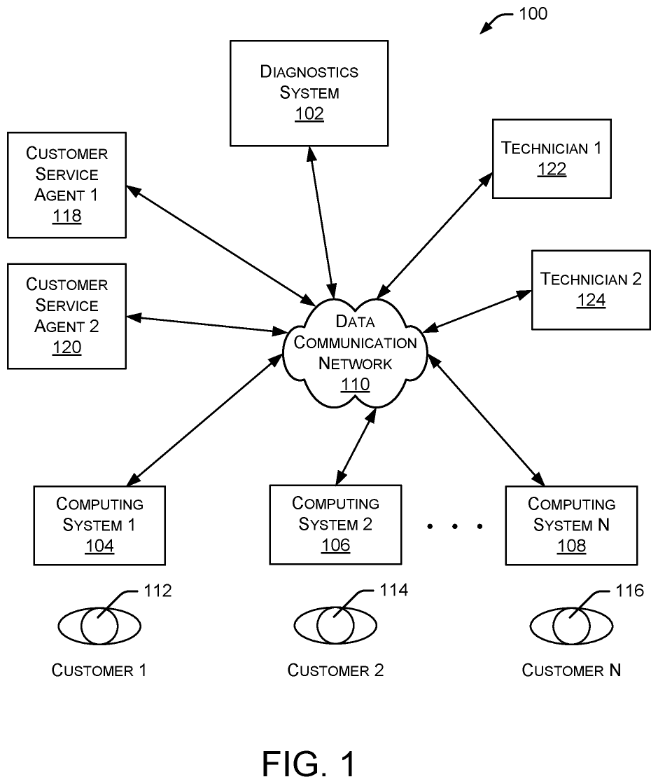

FIG. 1 is a block diagram illustrating an environment 100 within which an example embodiment may be implemented. As shown in FIG. 1, a diagnostics system 102 and multiple computing systems 104, 106, and 108 are coupled to a data communication network 110. Additionally, customer service agents 118 and 120 as well as technicians 122 and 124 are coupled to data communication network 110. Diagnostics system 102 performs various operations to diagnose customer issues and provide recommended solutions, as discussed herein. Computing systems 104, 106, and 108 allow customers 112, 114, and 116 to interact with diagnostics system 102, customer service agents 118 and 120, and technicians 122 and 124. For example, if customer 112 has a problem with a home-related system, they can communicate with customer service agent 118 who may diagnose the problem with the help of diagnostics system 102. In some situations, customer service agent 118 may transfer customer 112 to technician 124 for further assistance. As used herein, customers may also be referred to as “users.”

Although two customer service agents 118 and 120, and two technicians 122 and 124 are shown in FIG. 1, particular implementations may include any number of customer service agents and any number of technicians. In some embodiments, customer service agents 118 and 120 are human agents that engage with customers via voice, text, email, or other communication systems. In other embodiments, a particular customer service agent may be an automated system that communicates with a customer by generating automated messages based on an analysis of the customer's question and messages.

Data communication network 110 includes any type of network topology using any communication protocol. Additionally, data communication network 110 may include a combination of two or more communication networks. In some embodiments, data communication network 110 includes a cellular communication network, the Internet, a local area network, a wide area network, or any other communication network. Computing systems 104, 106, and 108 may include any type of computing device, such as a desktop computer, a laptop computer, a mobile device, a microprocessor-based or programmable consumer electronic device, a network PC, a minicomputer, a mainframe computer, a PDA, a smartphone, a tablet, and the like. As discussed herein, customers may interact with a particular computing system 104, 106, and 108, to obtain help with an issue, such as a home-related issue or problem. Although three computing systems 104, 106, and 108 and three customers 112, 114, and 116 are shown in FIG. 1, alternate embodiments may include any number of computing systems and any number of customers interacting with the computing systems.

In some embodiments, diagnostics system 102 and computing systems 104, 106, and 108 are each located in a different geographic location. For example, diagnostics system 102 may be located at a first geographic location associated with a business and each computing system 104, 106, and 108 is located at a different geographic location associated with a customer's current location. Similarly, in some embodiments, customer service agents 118 and 120 are located in different geographic areas, and technicians 122 and 124 are located in different geographic areas from each other and different from the customer service agents.

Although not shown in FIG. 1, some embodiments of environment 100 may include systems that implement various communication channels via chatbots, graphical user interfaces (e.g., via websites), mobile apps, and the like.

It will be appreciated that the embodiment of FIG. 1 is given by way of example only. Other embodiments may include fewer or additional components without departing from the scope of the disclosure. Additionally, illustrated components may be combined or included within other components without limitation.

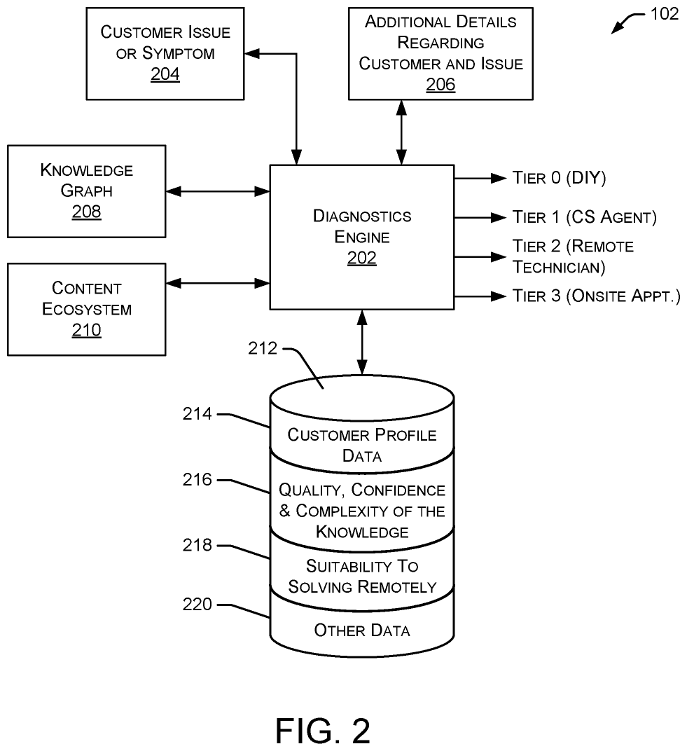

FIG. 2 is a block diagram illustrating an embodiment of diagnostic system 102, which includes a diagnostics engine 202. Diagnostics engine 202 performs various functions to diagnose and prioritize customer issues, as discussed herein. As shown in FIG. 2, diagnostics engine 202 is coupled to receive information 204 related to a customer issue or symptom. This information may include, for example, a description of the issue (e.g., the furnace won't work), current conditions (e.g., the pipe under the kitchen sink is leaking), a severity of the problem (e.g., the leak is flooding the basement), and the like. This information is received from a customer via a conversation with a customer service agent, a text message, an email message, or other communication.

Diagnostics engine 202 is also coupled to receive additional details 206 regarding the customer and the issue. These additional details may include information about issues and problems experienced by similar customers, previous interactions with customer service agents, previous interactions with technicians, and the like. The additional details regarding the issue may include information related to the type of issue that the customer is experiencing (e.g., information related to a specific type of leak or specific problems with a furnace).

Diagnostics engine 202 is also coupled to receive information from a knowledge graph 208, which is a data model that stores information related to one or more subjects. In some embodiments, knowledge graph 208 includes data associated with a variety of problems faced by homeowners as well as potential solutions to those problems. As shown in FIG. 2, diagnostics engine 202 is further coupled to receive information from a content ecosystem 210. In some embodiments, content ecosystem 210 includes various informative articles, do-it-yourself articles, do-it-yourself videos, advice to a customer related to their problem or issue, and the like.

Diagnostics engine 202 also receives various data from a database 212. As shown in FIG. 2, database 212 includes multiple categories of data: customer profile data 214, quality, confidence, and complexity of the knowledge 216, suitability to solving remotely 218, and other data 220. In some embodiments, customer profile data 214 may include information about the customer, such as geographic location, type of home, previous do-it-yourself (DIY) experience, and previous issues experienced by the customer. Quality, confidence, and complexity of the knowledge 216 includes, for example, information related to the complexity of a particular repair or activity, the ability of a customer to perform the particular repair or activity, and the like. Suitability to solving remotely 218 may include information about the difficulty of helping a customer perform a specific repair or activity (e.g., can a customer be expected to perform the repair or does it require a skilled technician). Other data 220 includes any other information that may be useful to diagnostics engine 202 in assisting the customer with resolving their current issue.

Diagnostics engine 202 generates multiple outputs that indicate how to best handle the customer's issue or problem. For example, Tier 0 indicates that the customer can resolve the issue themselves (e.g., do-it-yourself). In this situation, the customer may receive links to written documents, recorded videos, recorded audio, etc. explaining how to resolve the issue. Tier 1 indicates that the customer can resolve the issue with the help of a customer service agent (e.g., the customer service agent guides the customer through the process of resolving the issue). Tier 2 indicates that the customer can resolve the issue with the help of a skilled technician via a remote connection. For example, a remote technician who is an expert at resolving the customer's issue will help the customer correct the issue. Finally, Tier 3 indicates that the customer needs an onsite appointment with a skilled technician. For example, certain types of repairs require a trained (and possibly licensed) technician to resolve the issue in a safe and thorough manner. In this situation, the customer schedules an onsite appointment with a skilled technician in their geographic area.

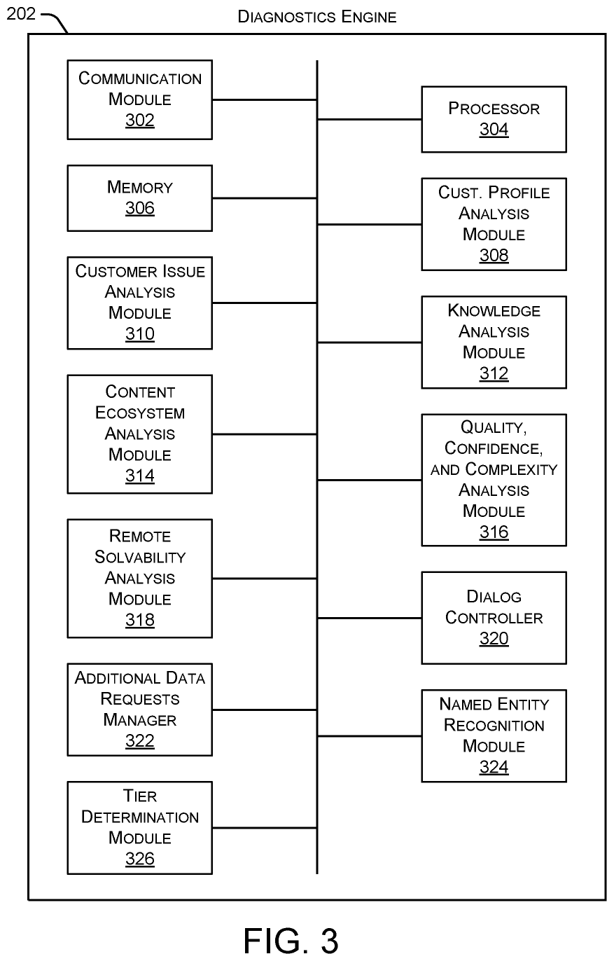

FIG. 3 is a block diagram illustrating an embodiment of diagnostics engine 202. As shown in FIG. 3, diagnostics engine 202 includes a communication module 302, a processor 304, and a memory 306. Communication module 302 allows diagnostics engine 202 to communicate with other systems, such as computing systems 104, 106, and 108, customer service agents 118 and 120, technicians 122 and 124, and the like. Processor 304 executes various instructions to perform the functionality provided by diagnostics engine 202, as discussed herein. Memory 306 stores these instructions as well as other data used by processor 304 and other modules and components contained in diagnostics engine 202.

Additionally, diagnostics engine 202 includes a customer profile analysis module 308 which identifies and analyzes customer profile data associated with multiple customers, such as customer profile data 214 (FIG. 2). Customer profile information includes, for example, customer identification information, geographic location, type of home, past issue resolution experience, do-it-yourself preferences, do-it-yourself skills, and the like. A customer issue analysis module 310 manages the analysis of a customer's particular issue and symptoms associated with the issue. A knowledge analysis module 312 analyzes various knowledge sources, such as knowledge graph 208 (FIG. 2). A content ecosystem analysis module 314 analyzes various content ecosystems, such as content ecosystem 208 (FIG. 2).

Diagnostics engine 202 further includes a quality, confidence and complexity analysis module 316 that analyzes various quality, confidence and complexity of the knowledge information, such as 216 shown in FIG. 2. A remote solvability analysis module 318 determines the likelihood of resolving a customer's issue remotely (e.g., using a chatbot, a mobile app, a remote customer service agent, or a remote technician) based on various data and other information of the type discussed herein.

Additionally, diagnostics engine 202 includes a dialog controller 320 that manages and suggests dialog between, for example, a customer and a customer service agent, a remote technician, a chatbot, a mobile app, and a user interface. Although particular examples discussed herein describe a dialog between a customer and a customer service agent, in other embodiments, the customer may communicate with chatbots, via a mobile app, via a user interface (e.g., through a website), or using any other communication channel. Dialog controller 320 can manage and suggest dialog with a customer via any type of communication channel.

An additional data requests manager 322 generates requests for additional information regarding an issue or symptoms. In some embodiments the generated requests are communicated to a customer service agent to ask as questions to the customer. In other embodiments, the generated requests are communicated to a customer via any available communication channel, such as via a chatbot, a mobile app, a graphical user interface, and the like. A named entity recognition module 324 extracts data (such as customer name, location, symptom, etc.) from customer communications, such as text messages, email messages, spoken words, and the like. A tier determination module 326 determines an appropriate tier for a particular customer issue using the systems and methods discussed herein. In one embodiment, the systems and methods identify one of four tiers (Tier 0, Tier 1, Tier 2, and Tier 3), each of which resolves the customer's issue in a different manner.

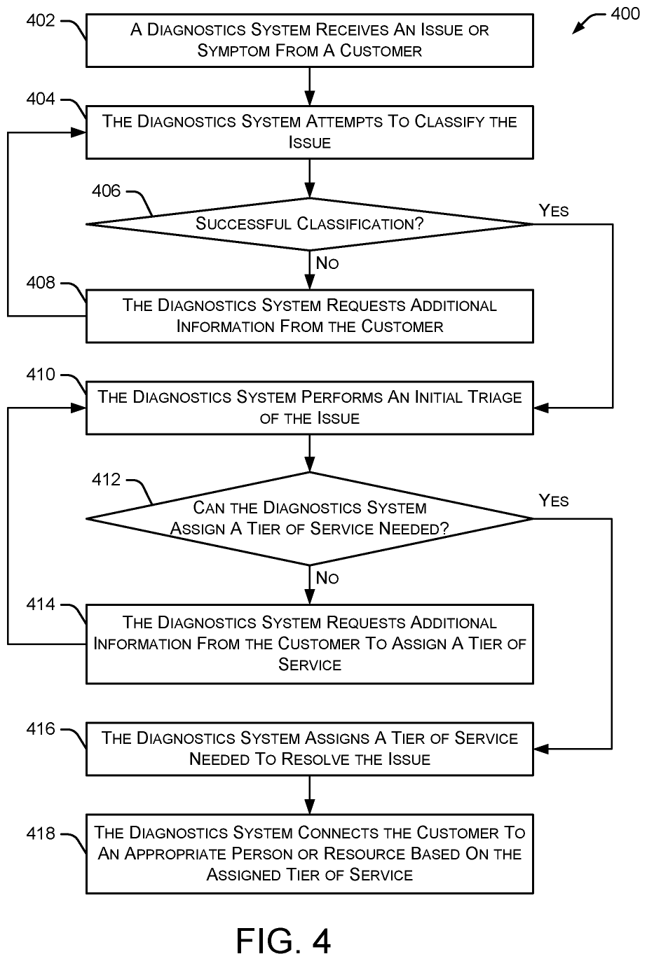

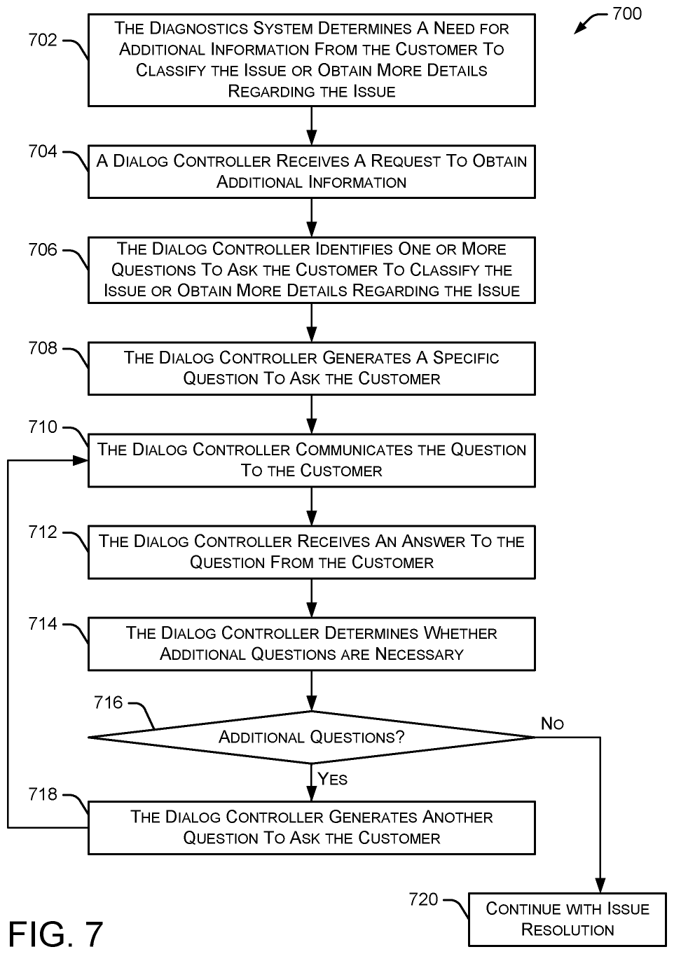

FIG. 4 is a flow diagram illustrating an embodiment of a method 400 for diagnosing a problem. Initially, a diagnostics system receives 402 an issue or symptom from a customer. The diagnostics system attempts to classify 404 the issue based on various information. If the classification of the issue is not successful at 406, method 400 continues as the diagnostics system requests 408 additional information from the customer. The method then returns to 404 and continues attempting to classify the issue. In some implementations, when the diagnostics system attempts to classify the issue, it identifies possible causes of the customer's symptoms. If there are multiple possible causes that would require different resolutions (or different costs), the diagnostics system determines what information is necessary to narrow down the multiple possible causes to a single cause or a smaller set of causes that can be resolved in the same manner (e.g., resolved using the same tier of service). In some embodiments, the diagnostics system generates questions for a customer in an effort to accurately classify the customer's issue. As discussed herein, these questions can be communicated to a customer via a variety of communication channels, such as live interaction with a customer service agent, a chatbot, a mobile app, a graphical user interface, and the like. Additional details regarding the generation of questions for the customer are provided herein and, in particular, with respect to FIG. 7.

If the classification of the issue is successful at 406, method 400 continues with the diagnostics system performing 410 an initial triage of the issue. Based on the initial triage, the diagnostics system attempts to assign a tier of service or resolution needed for the issue. If the diagnostics system is not able to assign a tier of service needed at 412, method 400 continues to 414 where the diagnostics system requests additional information from the customer to assign a tier of service. The method then returns to 410 to perform another triage in an attempt to assign a tier of service.

In some embodiments, the tier of service required to solve a particular issue is stored in knowledge graph 208. The diagnostics system attempts to ask questions to narrow the list of possible causes down to one.

If the diagnostics system is able to assign a tier of service needed at 412, method 400 continues with the diagnostics system assigning 416 a tier of service needed to resolve the issue. The diagnostics system then connects 418 the customer to an appropriate person or resource based on the assigned tier of service. For example, if the assigned tier of service is Tier 2 (remote technician), the diagnostics system connects the customer with an available remote technician to help resolve their issue.

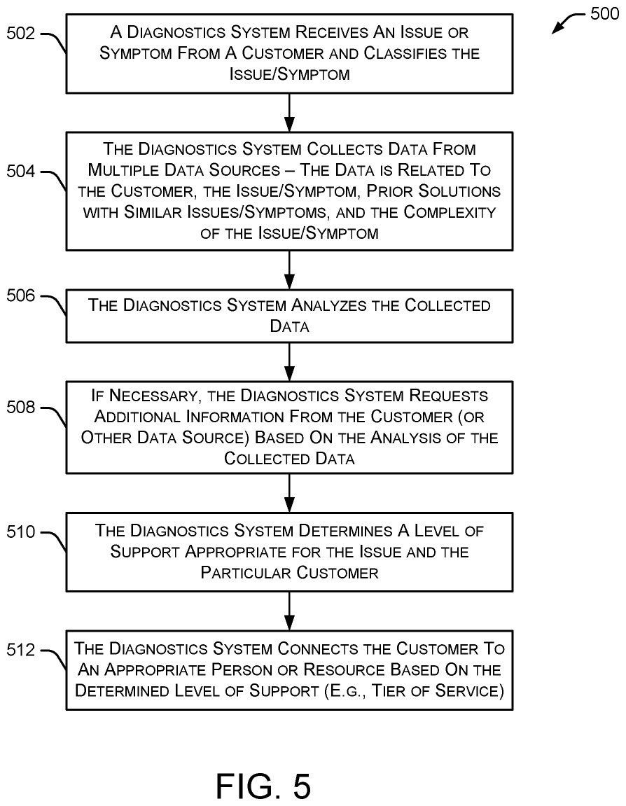

FIG. 5 is a flow diagram illustrating an embodiment of a method 500 for selecting a tier of service. Initially, a diagnostics system receives 502 an issue or symptom from a customer and classifies the issue or symptom as discussed above with respect to FIG. 4. The diagnostics system then collects 504 data from multiple data sources. In some embodiments, this data is related to the customer, the issue/symptom, prior solutions with similar issues/symptoms, and the complexity of the issue/symptom (e.g., a difficulty associated with resolving the issue/symptom).

Method 500 continues as the diagnostics system analyzes 506 the data collected at 504. In particular embodiments, the diagnostics system is analyzing the collected data to determine a tier of service needed to resolve the issue/symptom. If necessary, the diagnostics system requests 508 additional information from the customer or other data source based on the analysis of the collected data. For example, more information may be required to properly determine the tier of service needed for the particular issue. The method continues as the diagnostics system determines 510 a level of support (e.g., a tier of service) appropriate for the issue and the particular customer.

In some embodiments, the tier of service required to resolve a particular issue is determined based on machine learning classifiers that classify every issue as to whether the issue is suitable for do-it-yourself service, customer service agent support, remote technician support, or requires an onsite technician appointment. In a particular implementation, large sets of labeled training data are created for the issues contained in knowledge graph 208. A classifier is then trained such that it can be applied to all possible issues. The described systems and methods may use a combination of automated analysis and technician review to accumulate the training data required to build the classifiers. In some embodiments, the systems and methods may also consider input from the customer as to their willingness to perform do-it-yourself activities.

After determining a level of support appropriate for the issue and the particular customer, the diagnostics system connects 512 the customer to an appropriate person or resource based on the determined level of support. For example, four different levels of support (Tier 0, Tier 1, Tier 2, and Tier 3) are illustrated in FIG. 2.

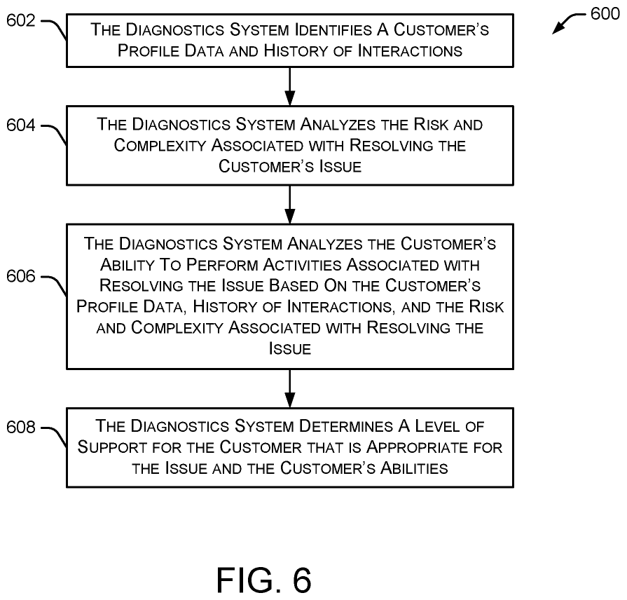

FIG. 6 is a flow diagram illustrating an embodiment of a method 600 for interacting with a customer to resolve the customer's issue. Initially, the diagnostics system identifies 602 a customer's profile data and history of interactions (e.g., previous interactions with do-it-yourself support, customer service agents, remote technicians, and onsite technician appointments). The diagnostics system then analyzes 604 the risk and complexity associated with resolving the customer's issue, as discussed herein. Method 600 continues as the diagnostics system analyzes 606 the customer's ability to perform activities associated with resolving the issue. In some embodiments, this analysis 606 is based on the customer's profile data, the customer's history of interactions, and the risk and complexity associated with resolving the customer's issue. The diagnostics system also determines a level of support for the customer that is appropriate for the particular issue and the customer's abilities.

FIG. 7 is a flow diagram illustrating an embodiment of a method 700 for generating questions to ask a customer. Initially, the diagnostics system determines 702 a need for additional information from the customer to classify the issue or obtain more details regarding the issue. A dialog controller (e.g., dialog controller 320 in FIG. 3) receives 704 a request to obtain additional information. The dialog controller identifies 706 one or more questions to ask the customer to classify the issue or obtain more details regarding the issue. The dialog controller then generates 708 a specific question to ask the customer.

In some embodiments, the questions to ask the customer are generated using a combination of template questions and machine learning models. These machine learning models receive the issues that need to be diagnosed and generate a question to ask the customer. In some situations, a machine learning model can receive a segment of text and generate one or more questions based on the text. The template questions may be stored in knowledge graph 208, or any other storage system, along with the related issues or symptoms. In some embodiments, the diagnostics system first attempts to use the template questions to generate questions to ask the customer. If the template questions are not sufficient, the diagnostics system may use the machine learning model.

Method 700 continues as the dialog controller communicates 710 the generated question to the customer. As discussed herein, the question can be communicated to the customer using any communication channel, such as a live customer service agent, a chatbot, a mobile app, a graphical user interface, and the like. The systems and methods described herein use an appropriate communication channel to communicate with the customer by asking the question and receiving an answer from the customer. The dialog controller then receives 712 an answer to the question from the customer. In some embodiments, the answer is automatically extracted from the conversation with the customer. For example, the answer may be extracted from voice transcription, a chat text dialog, and the like. When the customer is communicating with a live customer service agent, the agent may interact and ask additional questions to generate additional answers. The customer service agent may also provide additional information to the customer that does not need to be extracted.

Based on the answer received from the customer, the dialog controller determines 714 whether additional questions are necessary to classify the issue. If additional questions are necessary to classify the issue at 716, the dialog controller generates 718 another question to ask the customer. The method then returns to 710 where the new question is communicated to the customer. If additional questions are not needed to classify the issue at 716, then the customer's issue is classified and method 700 continues with resolution 720 of the issue.

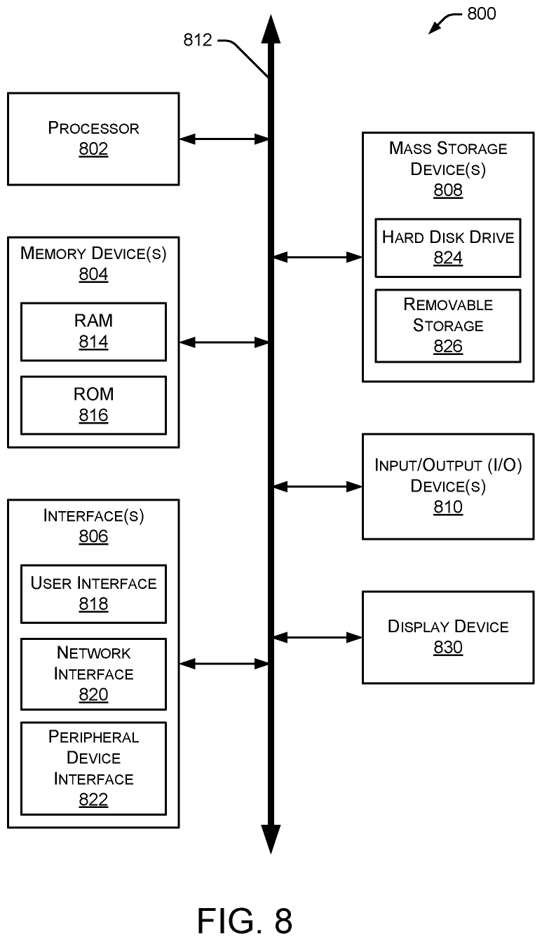

FIG. 8 is a block diagram illustrating an example computing device 800 suitable for implementing the systems and methods described herein. The diagnostics engine 202, computing systems 104, 106, and 108, and other devices described herein may also have some or all of the attributes of computing device 800. In some embodiments, a cluster of computing devices interconnected by a network may be used to implement any one or more components of the invention.

Computing device 800 may be used to perform various procedures, such as those discussed herein. Computing device 800 can function as a server, a client, or any other computing entity. Computing device can perform various monitoring functions as discussed herein, and can execute one or more application programs, such as the application programs described herein. Computing device 800 can be any of a wide variety of computing devices, such as a desktop computer, a notebook computer, a server computer, a handheld computer, tablet computer and the like.

Computing device 800 includes one or more processor(s) 802, one or more memory device(s) 804, one or more interface(s) 806, one or more mass storage device(s) 808, one or more Input/Output (I/O) device(s) 810, and a display device 830 all of which are coupled to a bus 812. Processor(s) 802 include one or more processors or controllers that execute instructions stored in memory device(s) 804 and/or mass storage device(s) 808. Processor(s) 802 may also include various types of computer-readable media, such as cache memory.

Memory device(s) 804 include various computer-readable media, such as volatile memory (e.g., random access memory (RAM) 814) and/or nonvolatile memory (e.g., read-only memory (ROM) 816). Memory device(s) 804 may also include rewritable ROM, such as Flash memory.

Mass storage device(s) 808 include various computer readable media, such as magnetic tapes, magnetic disks, optical disks, solid-state memory (e.g., Flash memory), and so forth. As shown in FIG. 8, a particular mass storage device is a hard disk drive 824. Various drives may also be included in mass storage device(s) 808 to enable reading from and/or writing to the various computer readable media. Mass storage device(s) 808 include removable media 826 and/or non-removable media.

I/O device(s) 810 include various devices that allow data and/or other information to be input to or retrieved from computing device 800. Example I/O device(s) 810 include cursor control devices, keyboards, keypads, microphones, monitors or other display devices, speakers, printers, network interface cards, modems, lenses, CCDs or other image capture devices, and the like.

Display device 830 includes any type of device capable of displaying information to one or more users of computing device 800. Examples of display device 830 include a monitor, display terminal, video projection device, and the like.

Interface(s) 806 include various interfaces that allow computing device 800 to interact with other systems, devices, or computing environments. Example interface(s) 806 include any number of different network interfaces 820, such as interfaces to local area networks (LANs), wide area networks (WANs), wireless networks, and the Internet. Other interface(s) include user interface 818 and peripheral device interface 822. The interface(s) 806 may also include one or more user interface elements 818. The interface(s) 806 may also include one or more peripheral interfaces such as interfaces for printers, pointing devices (mice, track pad, etc.), keyboards, and the like.

Bus 812 allows processor(s) 802, memory device(s) 804, interface(s) 806, mass storage device(s) 808, and I/O device(s) 810 to communicate with one another, as well as other devices or components coupled to bus 812. Bus 812 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 800, and are executed by processor(s) 802. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

While various embodiments of the present disclosure are described herein, it should be understood that they are presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the described exemplary embodiments, but should be defined only in accordance with the following claims and their equivalents. The description herein is presented for the purposes of illustration and description. It is not intended to be exhaustive or to limit the disclosure to the precise form disclosed. Many modifications and variations are possible in light of the disclosed teaching. Further, it should be noted that any or all of the alternate implementations discussed herein may be used in any combination desired to form additional hybrid implementations of the disclosure.

1. A diagnostics system comprising:
one or more processors; and
one or more non-transitory computer-readable media storing instructions executable by the one or more processors, wherein the instructions, when executed, cause the diagnostics system to perform operations comprising:
receiving a description of a home-related issue from a user;
identifying a user profile associated with the user;
determining a complexity associated with resolving the issue;
determining the user's ability to perform activities to resolve the issue based on the user profile and the complexity associated with resolving the issue; and
determining a level of support based on the user's ability to perform activities to resolve the issue.

2. The diagnostics system of claim 1, the operations further comprising providing the determined level of support to the user.

3. The diagnostics system of claim 1, the operations further comprising classifying the issue, wherein determining a complexity associated with resolving the issue is based on the classification of the issue.

4. The diagnostics system of claim 3, the operations further comprising generating a question to ask the user to assist in classifying the issue.

5. The diagnostics system of claim 4, the operations further comprising receiving an answer to the question from the user.

6. The diagnostics system of claim 1, wherein the level of support is determined from a plurality of levels of support.

7. The diagnostics system of claim 6, wherein the plurality of levels of support include at least one of a do-it-yourself level, a customer service agent level, a remote technician level, and an onsite appointment level.

8. The diagnostics system of claim 1, the operations further comprising identifying the user's history of interactions with the diagnostics system, wherein determining the user's ability to perform activities to resolve the issue is further based on the user's history of interactions with the diagnostics system.

9. A method comprising:
receiving, by a diagnostics system, a description of a home-related issue from a user;
identifying, by the diagnostics system, a user profile associated with the user;
determining, by the diagnostics system, a complexity associated with resolving the issue;
determining, by the diagnostics system, the user's ability to perform activities to resolve the issue based on the user profile and the complexity associated with resolving the issue; and
determining, by the diagnostics system, a level of support based on the user's ability to perform activities to resolve the issue.

10. The method of claim 9, further comprising providing the determined level of support to the user to resolve the issue.

11. The method of claim 9, further comprising classifying the issue, wherein determining the complexity associated with resolving the issue is based on the classification of the issue.

12. The method of claim 11, further comprising generating a question to ask the user to assist in classifying the issue.

13. The method of claim 9, wherein the level of support is determined from a plurality of levels of support.

14. The method of claim 13, wherein the plurality of levels of support include at least one of a do-it-yourself level, a customer service agent level, a remote technician level, and an onsite appointment level.

15. The method of claim 9, further comprising identifying the user's history of interactions with the diagnostics system, wherein determining the user's ability to perform activities to resolve the issue is further based on the user's history of interactions with the diagnostics system.

16. A method comprising:
receiving, by a diagnostics system, a description of a home-related issue from a user;
identifying, by the diagnostics system, a user profile associated with the user;
classifying, by the diagnostics system, the issue by generating at least one question to ask the user;
determining, by the diagnostics system, a complexity associated with resolving the issue;
determining, by the diagnostics system, the user's ability to perform activities to resolve the issue based on the user profile and the complexity associated with resolving the issue; and
determining, by the diagnostics system, a level of support based on the user's ability to perform activities to resolve the issue.

17. The method of claim 16, further comprising receiving an answer to the question from the user, wherein the received answer assists in classifying the issue.

18. The method of claim 16, wherein determining the complexity associated with resolving the issue is based on the classification of the issue.

19. The method of claim 16, wherein the level of support is determined from a plurality of levels of support.

20. The method of claim 16, wherein the plurality of levels of support include at least one of a do-it-yourself level, a customer service agent level, a remote technician level, and an onsite appointment level.
